(19) United States
(12) Patent Application Publication
(10) Pub. No.: US 2026/0313013 A1
(43) Pub. Date: Oct. 8, 2026

(54) METADATA-DRIVEN PRIORITIZATION OF AUDIO, VIDEO, AND DATA STREAMS

(71) Applicant: Haivision Systems Inc., Montreal (CA)

(72) Inventors: Nikolaos Kyriopoulos, Austin, TX (US); John Leipper, San Marcos, CA (US); Peter Maag, Montreal (CA); Jesús Oliva, Madrid (ES)

(21) Appl. No.: 19/558,929

(22) Filed: Mar. 6, 2026

Related U.S. Application Data
(60) Provisional application No. 63/783,913, filed on Apr. 4, 2025.

(51) Int. Cl. H04L 65/80; H04L 65/401

(52) U.S. Cl. CPC H04L 65/80; H04L 65/401

(57) ABSTRACT

Audio, video, and data streams may be prioritized in real time based exclusively on metadata produced by external analytical agents. Externally captured streams are accompanied by metadata derived from independent analysis engines, including AI inference models, rule-based classifiers, signal-processing tools, or domain-specific analytics. A Metadata & Feedback Ingestion subsystem normalizes, timestamps, harmonizes, and aggregates such metadata—optionally incorporating Feedback Data or operational constraints from downstream systems. A Prioritization Engine, operating without accessing or analyzing raw media content and remaining fully inference-agnostic, computes priority scores and generates prioritization outputs for each stream based solely on externally generated metadata and external constraints. These prioritization outputs are consumed by external downstream systems that perform selection, grooming, transcoding, routing, or transmission of streams across constrained networks. The invention thereby enables scalable, distributed, and metadata-driven prioritization of heterogeneous media streams while maintaining strict separation between prioritization logic and downstream stream-handling operations.

### CROSS-REFERENCE TO RELATED APPLICATION

This application claims priority to U.S. Provisional Patent Application No. 63/783,913, filed Apr. 4, 2025, the entire contents of which are incorporated herein by reference.

### TECHNICAL FIELD

The present disclosure relates to systems and methods for real-time, metadata-driven prioritization of audio, video, and data streams (“streams”) originating from multiple independent sources. More particularly, the present disclosure concerns inference-agnostic techniques for assigning relative priority scores to streams using metadata generated by external analytical agents, including but not limited to metadata describing semantic content, scene characteristics, signal conditions, or quality-related attributes of the underlying media. The prioritization engine may interpret such externally-produced metadata—without performing native content or quality analysis—to generate prioritization outputs responsive to real-time operational constraints such as available bandwidth, compute capacity, storage limits, latency budgets, or link reliability.

The disclosed systems may operate within networked video infrastructures, multi-sensor platforms, broadcast and surveillance systems, distributed edge-cloud architectures, and other resource-constrained communication or processing pipelines that must determine which among many concurrent streams merit emphasis, transmission, storage, suppression, or additional handling. By relying solely on externally generated metadata, the present disclosure enables downstream or external subsystems to act upon prioritization outputs while maintaining a clean separation between content analysis, quality assessment, and prioritization logic.

### BACKGROUND

Modern multi-camera, multi-sensor, and multi-stream systems generate volumes of real-time audio, video, and data that often exceed the capacity of available transmission, compute, and storage resources. Network bandwidth limitations, latency constraints, and processing bottlenecks make it impractical to handle every stream simultaneously.

### BRIEF DESCRIPTION OF THE DRAWINGS

FIG. 1 is an example streaming network architecture.

FIG. 2 is a high-level overview of a metadata-driven prioritization system, showing Stream Ingestion 211a-211n, External Analytical Agents 220, Metadata & Feedback Ingestion 231, computation of Priority Scores 241 by a Prioritization Engine 240, and delivery of prioritization outputs to an External Stream-Selection, Grooming & Transcoding subsystem 250 prior to transmission over a Constrained Network 260 to Downstream Processing 270.

FIG. 3 illustrates an example Stream-Acquisition and Metadata-Driven Prioritization workflow, showing the flow of audio, video, and data streams 311a-311n to External Analytical Agents 320, ingestion and normalization of metadata 331, computation of Priority Scores 341 by a Prioritization Engine 340, and provision of prioritization outputs to an External Stream-Selection, Grooming & Transcoding subsystem 350 prior to transmission over a Constrained Network 360 and subsequent transmission, with telemetry and feedback data 372, back to Prioritization Engine 340.

FIG. 4 illustrates an edge-deployed prioritization embodiment in which local capture 410, External Analytical Agents 420, Metadata & Feedback Ingestion 431, and a Prioritization Engine 440, optionally in conjunction with a Decision Module 445, operate together to compute priority scores that are delivered to an External Stream-Selection, Grooming & Transcoding subsystem 450 for transmission across a Constrained Network 460. Telemetry and feedback originating from downstream systems 472 may be provided back to the Metadata & Feedback Ingestion subsystem as external inputs.

FIG. 5 is a system-interaction diagram showing Stream Ingestion 510, External Analytical Agents 520, Metadata & Feedback Ingestion 531, the Prioritization Engine 540, and an External Stream-Selection, Grooming & Transcoding subsystem 550 configured to forward selected or groomed streams across a Constrained Network 560, with Downstream Telemetry & Feedback 572 providing operational constraints and adaptive overrides.

FIG. 6 illustrates a cascaded or federated multi-node prioritization architecture in which prioritization may occur at multiple workflow stages—including Edge Prioritization Nodes 610, Aggregation/Regional Prioritization Nodes 630, and Central/Cloud Prioritization Nodes 640. Metadata, priority scores, and operational constraints may be exchanged bidirectionally among nodes to support coordinated multi-stage prioritization prior to forwarding selected or groomed streams to Downstream Processing Systems 670. Each of the Edge Prioritization Nodes 610, Aggregation/Regional Prioritization Nodes 630, and Central/Cloud Prioritization Nodes 640 represents a respective deployment instance of the Metadata & Feedback Ingestion subsystem and the Prioritization Engine at a corresponding workflow stage, rather than distinct functional components. In this manner, prioritization logic may be distributed across edge, aggregation, and centralized environments while maintaining consistent, metadata-driven prioritization behavior across the overall system.

FIG. 7 illustrates an example prioritization sequence for a multi-stream deployment, showing External Analytical Agents 720 processing surveillance-camera feeds 711a-711n, computation of prioritization outputs by a Prioritization Engine 740, delivery of those outputs to an External Stream-Selection, Grooming & Transmission subsystem 750, and subsequent forwarding of selected or groomed audio, video, and data streams across a Constrained Network 760.

### DETAILED DESCRIPTION

Without a mechanism to determine which streams carry the most relevant information, systems can become overloaded, resulting in congestion, degraded performance, and reduced situational awareness.

Some systems address transport, encoding, or reliability, but generally do not determine which streams should be prioritized under constrained operating conditions. For example, transport protocols such as SRT, RIST, and Zixi provide reliable delivery but do not determine which streams merit transmission, adaptive bitrate mechanisms adjust encoding parameters but assume all streams remain active, and bonded-cellular systems increase bandwidth but still forward every available feed. Further, AI analytics may classify or detect events, but their outputs typically do not influence upstream stream-selection decisions, and routing, QoS, and traffic-management systems apply static rules rather than externally generated, content-aware metadata. As a result, such systems therefore do not evaluate multiple streams, rank them based solely on metadata produced by external analytical agents, and select only the most relevant streams under real-time resource constraints.

There is a need for a system that uses externally generated metadata to determine the relative importance of multiple concurrent streams and to select the highest-value information when transmission, compute, or storage resources are constrained. Such a system would ideally operate in an inference-agnostic manner—without requiring internal content or quality analysis—and support deployment across edge, cloud, and hybrid environments. It would further benefit downstream systems by providing focused, context-aware prioritization signals that reduce unnecessary data movement and processing while preserving critical content.

The present disclosure provides systems and methods for real-time, metadata-driven prioritization of audio, video, and data streams (“streams”) received from multiple independent sources. A plurality of streams are ingested together with metadata produced by external analytical agents, including AI inference engines, classification or detection models, rule-based processors, signal-analysis tools, and other domain-specific analytics. These agents may further compute quality-related attributes of the underlying media—such as estimated video quality, resolution characteristics, compression-artifact indicators, or audio-intelligibility scores—which are supplied as metadata and treated as external inputs to the prioritization engine.

The prioritization engine may be inference-agnostic (e.g., operating based on metadata produced by external agents, irrespective of the inference methods those agents use) and may operate without performing native content or quality analysis. In various embodiments, the prioritization engine relies entirely on externally generated metadata. Internal indicators, where present, may be incorporated without altering the metadata-driven nature of the prioritization workflow and without performing any internal inference or content analysis.

Systems according to the present disclosure may include a metadata and feedback ingestion subsystem that normalizes, timestamps, and harmonizes metadata received from one or more external analytical agents and downstream feedback sources. The prioritization engine computes a dynamic priority score for each stream based on externally generated metadata, optional feedback, and real-time operational constraints—including available bandwidth, compute load, storage capacity, latency budgets, or link reliability. Operational constraints are treated as external inputs that influence prioritization outcomes.

Based on these computations, the system produces prioritization outputs that convey priority scores or prioritization states for respective streams. These outputs are provided to external stream-selection, routing, or grooming subsystems through a distinct interface or API. In some embodiments, the prioritization system, or the computing architecture of which it is a part, does not perform selection, routing, transcoding, or transport; these operations may be carried out by external subsystems that interpret and act upon the prioritization outputs generated by the prioritization system.

In certain embodiments, the system incorporates feedback signals originating from external grooming or transport systems, operator consoles, analytics confirmations, or telemetry sources. This feedback enables dynamic adjustment of prioritization behavior in response to evolving network conditions or operational objectives. Feedback may include congestion metrics, operator preferences, mission relevance indicators, bandwidth budgets, or quality-of-service signals.

Additional embodiments support distributed or federated deployments, in which metadata, priority scores, and constraint data are exchanged among multiple workflow stages—such as edge devices, aggregation nodes, and centralized or cloud-based processors—to maintain coordinated prioritization across heterogeneous infrastructures. Business-rule metadata originating from enterprise systems or orchestration frameworks may also influence priority scoring in accordance with service tiers, policy requirements, or mission objectives.

The present disclosure thereby enables resource-constrained systems to determine, in real-time and with minimal overhead, which streams warrant higher priority under current conditions. By concentrating limited resources on the most relevant or highest-value information, the disclosure improves system efficiency, reduces unnecessary data movement, enhances situational awareness, and supports scalable multi-stream processing across commercial, industrial, broadcast, public-safety, security, and defense environments.

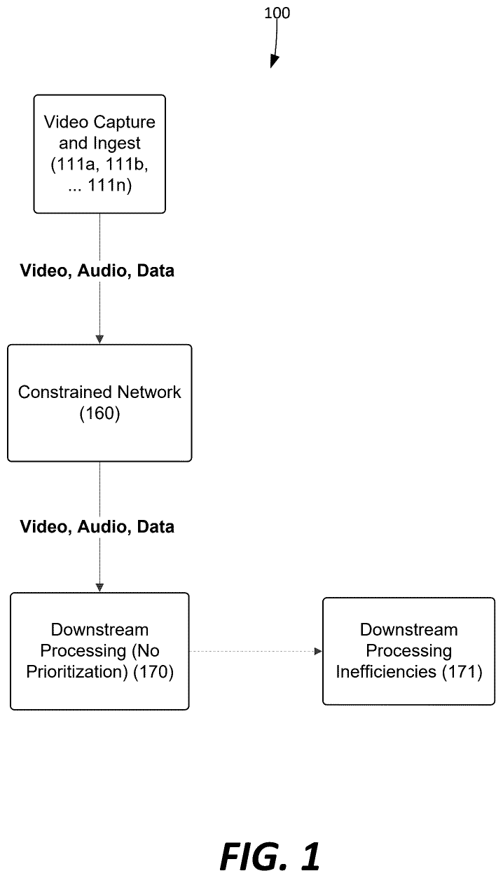

System Architecture Overview. FIG. 1 illustrates a system architecture 100 where multiple audio, video, or data streams 111a-111n are forwarded across a constrained network 160 without metadata-driven prioritization. As a result, the system 100 experiences inefficient downstream processing 170 and associated processing inefficiencies 171.

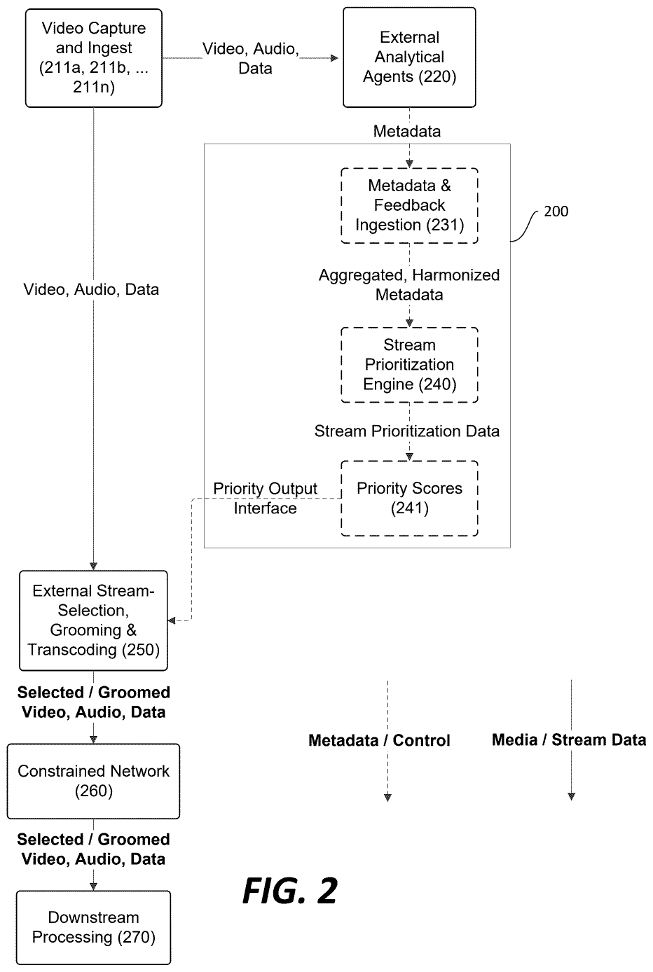

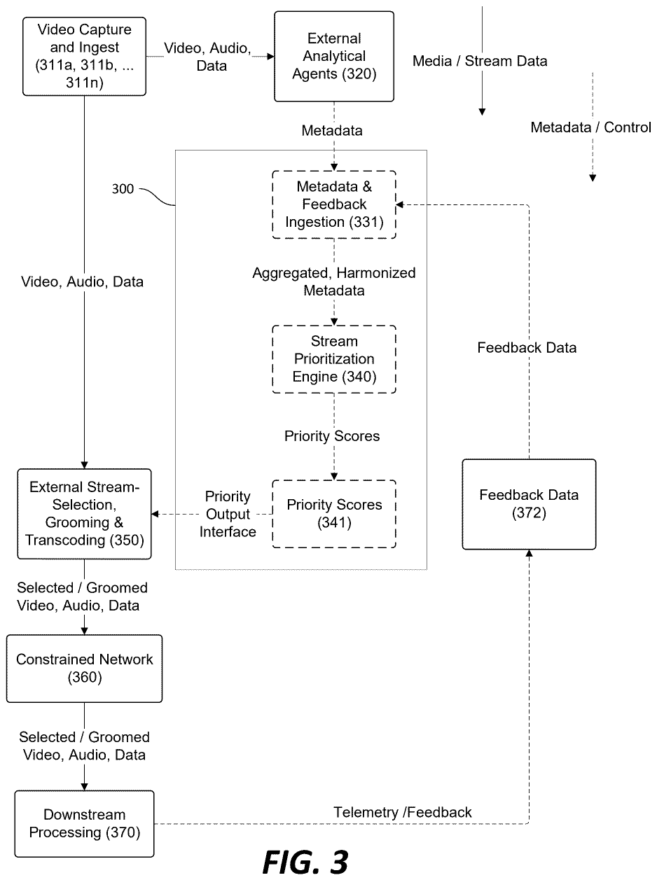

Additional system architecture embodiments described herein implement a metadata-driven prioritization system. FIG. 2 is one such architecture, in which a prioritization system 200 receives external streams 211a, 211b, . . . 211n and data from external analytics agents. The prioritization system 200 may include a metadata and feedback ingestion subsystem 231, a stream prioritization engine 240, and generated priority scores 241. The prioritization system is also included in FIGS. 3, 4, 5, and 7 as prioritization system 300, 400, 500, 700.

In some embodiments, externally captured streams (e.g., 211a-211n, 311a-311n, 410, 510, 610, 711a-711n) are accompanied by externally generated metadata supplied by External Analytical Agents 220, 320, 420, 520, 720. This metadata is ingested, normalized, and evaluated by internal components of the prioritization system 200, 300, 400, 500, 700—namely, the Metadata and Feedback Ingestion subsystem, the Prioritization Engine, and, in some embodiments, an optional Decision Module—to compute priority scores for each stream under prevailing operational constraints.

This disclosure makes reference to “streams.” A stream may be or may include any sequence, flow, or collection of information units transmitted or made available over time from a source to a receiving system. Streams may include, without limitation: real-time or near-real-time media content such as video, audio, or multimedia signals; data streams including sensor data, telemetry, measurement vectors, event logs, system diagnostics, or communication signals; metadata streams including AI-generated metadata, inference outputs, classification labels, detection results, quality scores, operational data, or contextual descriptors; packet-based or frame-based digital content, whether continuous, bursty, or intermittent; file-based content treated as a stream for prioritization purposes. Unless stated otherwise, the term “stream” in this disclosure encompasses any such media, data, or metadata source individually or in combination.

Metadata that may be utilized in stream prioritization in this disclosure may be or may include structured or unstructured information associated with a stream that describes analytical, contextual, operational, quality-related, or business-related attributes. Metadata may include object-detection outputs, anomaly indicators, activity classifications, scene descriptors, motion levels, geospatial context, estimated video or audio quality metrics, or business-rule information. Metadata may be generated by external analytical agents, in embodiments.

Unless expressly stated otherwise, the following components are internal to the prioritization system: Metadata & Feedback Ingestion (231, 331, 431, 531); the Prioritization Engine (240, 340, 440, 540, 740); computation of priority scores (241, 341); and evaluation of operational constraints and, where applicable, operation of a Decision Module (445) configured to format or expose prioritization outputs without performing any stream-selection, routing, grooming, transcoding, or transport operations. Grooming may be or may include a set of operations performed that select, suppress, forward, adapt, or otherwise modify the handling of streams based on priority scores and operational constraints.

The following components are external to the prioritization system, in embodiments: stream-capture devices or encoders that produce input streams (e.g., 111a-111n, 211a-211n, 311a-311n, 711a-711n); Video Capture and Ingest that produce input streams (410, 510); External Analytical Agents (220, 320, 420, 520, 720) that generate metadata describing analytical or contextual characteristics of streams; external stream-selection, grooming, and transcoding subsystems (250, 350, 450, 550, 750), which act upon prioritization outputs generated by the prioritization system; transport networks (160, 260, 360, 460, 560, 760); and downstream processing, monitoring, storage, and distribution systems (170, 270, 370, 470, 570, 670).

In embodiments, the prioritization system 200 does not itself perform encoding, decoding, routing, grooming, transcoding, or media transport, but it enables performing those functions better. The following subsections describe internal and external components and their interactions with reference to FIGS. 2-7.

The Metadata & Feedback Ingestion component or subsystem 231, 331, 431, 531 may ingest, normalize, aggregate, and harmonize metadata originating from external analytical agents and operational feedback from downstream systems. In certain embodiments, a feedback-ingestion module operates as a logical sub-component of this subsystem, treating feedback as a specialized class of metadata processed through the same ingestion pipeline.

The Prioritization Engine 240, 340, 440, 540, 640, 740 may be or may include a decision-making component that computes priority scores for streams based on metadata and, optionally, feedback or operational constraints. In some embodiments, the prioritization engine may compute priority scores based solely on metadata. The prioritization engine performs no native content analysis and operates independently of external agents. A priority score may be or may include a numerical, ordinal, categorical, or symbolic representation assigned to a stream reflecting its relative importance or relevance. Priority scores influence external stream-handling decisions but do not by themselves dictate such decisions.

The operational constraints that may be considered by the prioritization engine may be or may include real-time limitations, including available bandwidth, latency budgets, compute load, storage limits, or link reliability. Operational constraints may include dynamic inputs such as congestion metrics, operator directives, bandwidth budgets, or policy overrides provided by downstream systems. Operational constraints may include both constraints directly between the prioritization system and immediately connected external systems (which may be reported back by those connected systems, for example). Operational constraints may also include constraints respective of further-downstream systems and provided to the prioritization system as feedback and telemetry data as described herein.

External Capture and Metadata Generation. A plurality of external capture devices—such as cameras, sensors, or encoders—produce audio, video, or data streams (e.g., 211a-211n, 311a-311n, 410, 510, 711a-711n, as shown in FIGS. 2-7). These capture devices may be external to the prioritization system 200, 300, 400, 500, 700 and supply input streams that the prioritization system 200, 300, 400, 500, 700 may prioritize. The prioritization system 200, 300, 400, 500, 700 does not perform, direct, configure, or control any media-capture operations, in embodiments.

External Analytical Agents 220, 320, 420, 520, 720 operate independently of the prioritization system 200, 300, 400, 500, 700 to perform object detection, activity recognition, scene classification, anomaly detection, rule-based analysis, quality estimation, or other analytical or contextual evaluations. These agents generate metadata describing properties or characteristics of the corresponding streams and deliver such metadata to the inventive system for ingestion. Metadata generation is entirely external to the prioritization system 200, 300, 400, 500, 700, and the prioritization system 200, 300, 400, 500, 700 imposes no requirements on the models, algorithms, or internal operations used by these analytical agents, in embodiments.

The prioritization engine 240, 340, 440, 540, 640, 740 does not analyze or interpret raw audio, video, or data content, in embodiments. Instead, it may operate on metadata (e.g., solely on metadata) supplied by the external analytical agents and is therefore inference-agnostic.

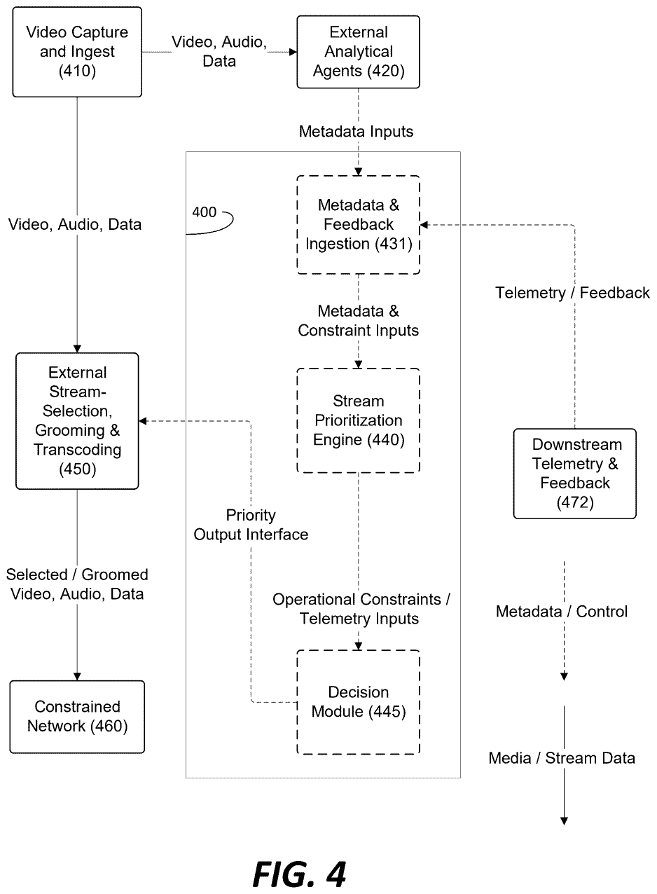

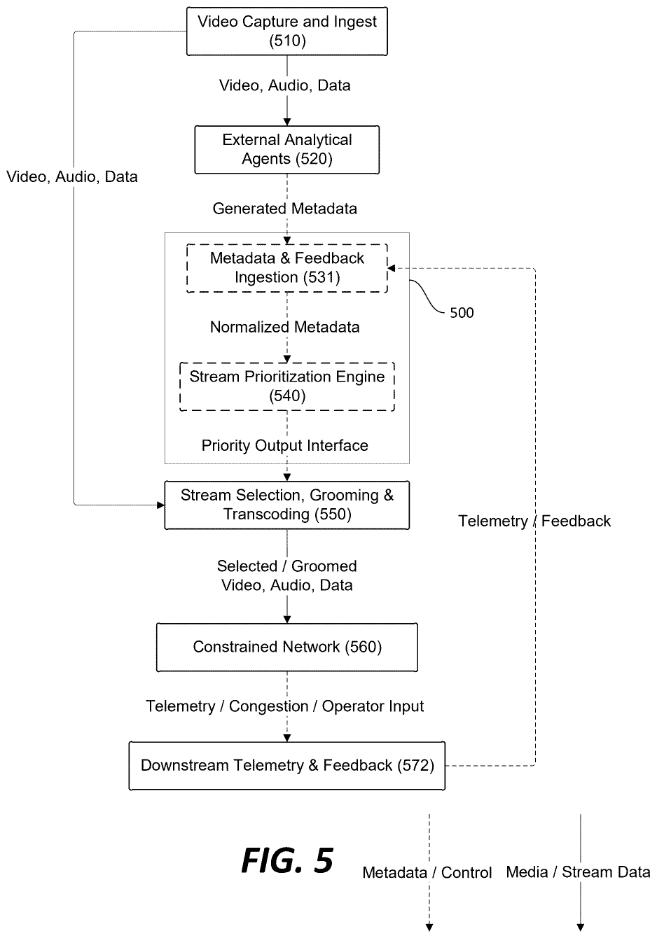

Metadata & Feedback Ingestion (Internal). The Metadata & Feedback Ingestion subsystem-shown in FIG. 2 (231), FIG. 3 (331), FIG. 4 (431), and FIG. 5 (531) may receive metadata generated by External Analytical Agents and prepares such metadata for evaluation by the Prioritization Engine 240, 340, 440, 540, 640, 740.

The Metadata & Feedback Ingestion subsystem 231, 331, 431, 531 may normalize, timestamp, harmonize, or aggregate metadata received from multiple external agents 220, 320, 420, 520, 720 or workflow stages (which may include any point in a multi-component processing architecture at which streams or metadata are ingested, prioritized, evaluated, or forwarded; workflow stages may operate autonomously or exchange metadata and constraints with other stages) to produce a unified representation suitable for prioritization. Each such external agent 220, 320, 420, 520, 720 may be or may include a software or hardware process external to the prioritization engine that generates metadata describing analytical, contextual, or operational characteristics of a stream. Example external agents 220, 320, 420, 520, 720 include AI inference engines, machine-learning models, rule-based processors, signal-analysis tools, and other domain-specific analytics modules. In some embodiments, metadata may arrive in heterogeneous formats or at different temporal resolutions, and the ingestion subsystem aligns or reconciles such data without altering its semantic meaning.

The Metadata & Feedback Ingestion subsystem 231, 331, 431, 531 may also receive Telemetry and Feedback Data originating from downstream systems, operator inputs, analytics confirmations, or network-performance indicators. Such feedback is treated as an external input that may influence prioritization scores but does not enable the prioritization system 200, 300, 400, 500, 700 to control or configure any downstream subsystem. Telemetry and Feedback Data may be or may include information originating from external subsystems, telemetry sources, or user interactions that may be used to adjust priority scores or influence prioritization behavior. Telemetry and feedback data may include performance metrics, bandwidth or throughput indicators, packet-loss or error data, congestion signals, operator inputs, policy directives or overrides, service-level indicators, or externally determined stream-handling decisions, such as fixed or manual stream selections. Such telemetry and feedback data may serve as external input to the prioritization process and does not, in embodiments, cause the inventive system to originate, enforce, or execute stream selection, routing, grooming, transcoding, or transmission operations.

The ingestion subsystem does not perform content analysis, inference, classification, or semantic interpretation of audio, video, or data content. It also does not transform streams or metadata in a way that would constitute selection, routing, transcoding, filtering, grooming, or other downstream processing operations.

In some embodiments, the Metadata & Feedback Ingestion subsystem may be implemented as separate metadata-ingestion and feedback-ingestion modules, each operating within the inventive system as recited in the claims.

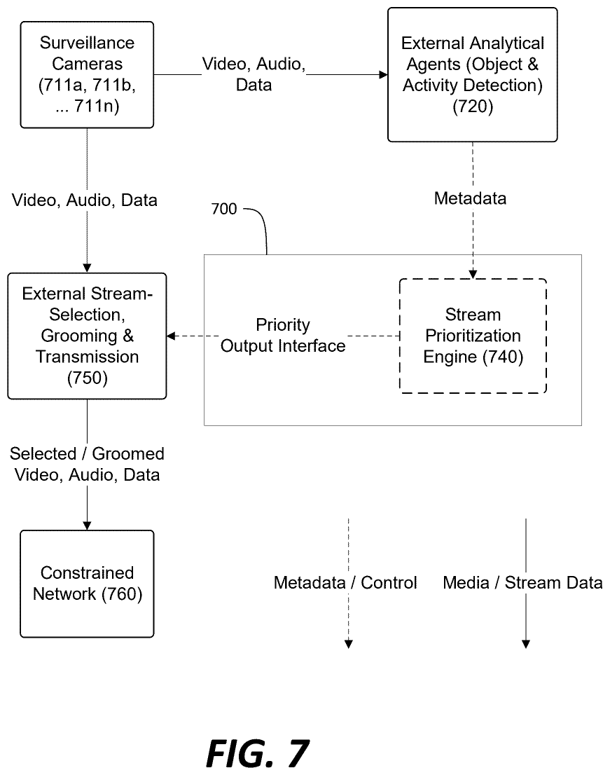

Prioritization Engine (Internal). The Prioritization Engine—shown in FIG. 2 (240), FIG. 3 (340), FIG. 4 (440), FIG. 5 (540), and FIG. 7 (740)—is an internal component of the prioritization system 200, 300, 400, 500, 700 that computes a priority score for each stream based solely on externally generated metadata, optional Feedback Data, and externally supplied operational constraints. The Prioritization Engine does not access, decode, or analyze raw audio, video, or data content.

The Prioritization Engine performs: no internal content analysis; no image or signal processing; no multimedia decoding; no inference, classification, or recognition operations.

The Prioritization Engine is therefore analytics-agnostic and inference-agnostic. In operation, the engine may continuously or periodically update priority scores as metadata, feedback, or operational constraints evolve.

The Prioritization Engine provides prioritization outputs—such as priority scores, priority-order information, or other prioritization states—through a distinct interface or API. These outputs are consumed exclusively by external subsystems, including External Stream-Selection, Grooming & Transcoding subsystems. The Prioritization Engine performs no stream selection, suppression, routing, grooming, encoding, transcoding, or transport operations.

In some embodiments, an optional Decision Module (e.g., FIG. 4, 445) may evaluate priority scores together with operational constraints to format prioritization outputs for downstream consumption. The Decision Module does not select, route, groom, filter, or transmit streams; it merely refines or structures prioritization information. In other embodiments, certain decision logic may be integrated into the Prioritization Engine while maintaining the inference-agnostic operation of the system.

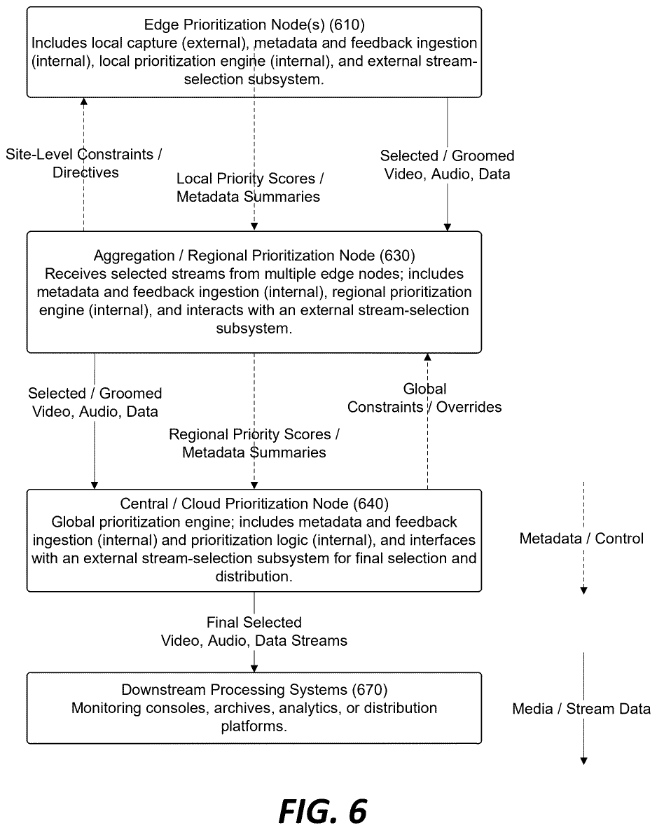

Constraint Evaluation and Decision Logic (Internal). As shown in FIG. 3 (e.g. 372→340), FIG. 4 (e.g. 472→440), FIG. 5 (e.g. 572→531) FIG. 6 (e.g., 640→630 and 630→610), various downstream or external systems may provide Telemetry or Feedback Data that reflect current operating conditions. Such feedback may include congestion metrics, available bandwidth or throughput budgets, operator directives, quality-of-service indicators, policy overrides, link-reliability metrics, storage limitations, cost constraints, business-rule directives, or other operational constraints. All such feedback sources are external to the prioritization system 200, 300, 400, 500, 700, in embodiments.

The Metadata & Feedback Ingestion subsystem receives and normalizes these feedback signals as external inputs. The Prioritization Engine may evaluate the feedback in combination with externally generated metadata to update priority scores. Operational constraints are treated purely as external parameters that influence the prioritization process, in embodiments. The prioritization system 200, 300, 400, 500, 700 does not compute, derive, or enforce these constraints, nor does it control or configure any downstream systems or networks, in embodiments.

Feedback and operational constraints serve to refine the prioritization outputs generated by the prioritization system 200, 300, 400, 500, 700. They do not trigger or perform selection, routing, grooming, transcoding, suppression, or transmission of streams. Those actions are performed by external systems that interpret the prioritization outputs produced by the prioritization system 200, 300, 400, 500, 700, in embodiments.

In some embodiments, feedback may be incorporated continuously or periodically, allowing the Prioritization Engine to adapt priority scores dynamically in response to evolving network conditions or operational requirements while maintaining inference-agnostic behavior.

External Stream Selection, Grooming & Transcoding. External Stream-Selection, Grooming & Transcoding subsystems—illustrated in FIG. 2 (250), FIG. 3 (350), FIG. 4 (450), FIG. 5 (550), and FIG. 7 (750)—operate entirely outside the prioritization system 200, 300, 400, 500, 700, in embodiments. These subsystems receive prioritization outputs generated by the Prioritization Engine and act upon those outputs to determine how streams are handled downstream.

The stream selection subsystem may receive priority scores and operational constraints and determine which streams are transmitted, suppressed, adapted, downscaled, transcoded, or otherwise groomed for downstream processing.

Such external subsystems may, for example: select one or more streams for transmission, suppress or discard lower-priority streams, adjust bitrates, resolutions, or encoding parameters, groom, filter, adapt, or transcode streams, route or forward selected or groomed streams across available network paths.

All such operations are performed exclusively by external systems and are not executed or controlled by the inventive system. The prioritization system 200, 300, 400, 500, 700 does not perform selection, suppression, adaptation, grooming, transcoding, routing, filtering, or transmission of audio, video, or data streams, in embodiments. The prioritization system 200, 300, 400, 500, 700 produces prioritization outputs—such as priority scores or prioritization states—that external subsystems may interpret and act upon as they determine appropriate.

External Stream-Selection, Grooming & Transcoding subsystems operate independently of the internal logic of the prioritization system 200, 300, 400, 500, 700 and do not alter the metadata-driven prioritization performed by the Prioritization Engine. These external systems act solely on the prioritization outputs and do not supply inference, analytic results, or content interpretations back to the prioritization system 200, 300, 400, 500, 700, except where provided as Feedback Data through the Metadata & Feedback Ingestion subsystem.

Downstream Transmission and Consumption. After external Stream-Selection, Grooming & Transcoding subsystems act on the prioritization outputs generated by the prioritization system 200, 300, 400, 500, 700, selected or groomed streams are transmitted across one or more Constrained Networks (e.g., FIG. 2, 260; FIG. 3, 360; FIG. 4, 460; FIG. 5, 560; FIG. 7, 760) by external downstream systems. The prioritization system 200, 300, 400, 500, 700 does not perform transmission, routing, grooming, filtering, transcoding, or any downstream handling of audio, video, or data streams, in embodiments.

Downstream consumption occurs within external systems such as monitoring platforms, processing pipelines, storage systems, cloud-based analytics, distribution frameworks, or operator consoles (e.g., FIG. 1, 170; FIG. 2, 270; FIG. 3, 370). These systems operate independently of the inventive prioritization system and are not configured or controlled by it.

In some embodiments, downstream systems may provide Telemetry and Feedback Data—such as congestion indicators, bandwidth budgets, operator inputs, or policy constraints—that may be ingested by the Metadata & Feedback Ingestion subsystem as external inputs. Such feedback influences the computation of prioritization outputs but does not alter the downstream systems themselves, which are external to the prioritization system 200, 300, 400, 500, 700.

This disclosure provides prioritization systems 200, 300, 400, 500, 700 that include a Metadata & Feedback Ingestion subsystem, a Prioritization Engine, and, in some embodiments, an optional Decision Module. These components receive externally generated metadata and, where applicable, Feedback Data or operational constraints supplied by external systems. The prioritization system 200, 300, 400, 500, 700 computes priority scores and associated prioritization outputs based on these external inputs.

The prioritization system 200, 300, 400, 500, 700 does not access, decode, analyze, or transform raw audio, video, or data content, in embodiments. It does not generate metadata, perform inference, execute grooming, selection, transcoding, routing, filtering, or transport operations, nor does it control downstream systems or networks, in embodiments. Stream handling, stream selection, grooming, adaptation, or transmission is performed by external subsystems that interpret the prioritization outputs generated by the prioritization system 200, 300, 400, 500, 700, in embodiments.

The prioritization system 200, 300, 400, 500, 700 is inference-agnostic and operates independently of the models, algorithms, or analytic methods employed by External Analytical Agents. External systems may optionally provide Feedback Data, but such feedback influences the prioritization computations and does not alter the functional boundaries of the prioritization system 200, 300, 400, 500, 700.

Operation of the Preferred Embodiment. In operation, and as illustrated in FIGS. 2, 3, 4, and 5, external capture devices generate audio, video, and data streams while External Analytical Agents (e.g., 220, 320, 420, 520) independently produce metadata describing analytical or contextual characteristics of these streams. All capture and metadata generation occur outside the inventive system.

The Metadata & Feedback Ingestion subsystem (231, 331, 431, 531) receives metadata from the External Analytical Agents 220, 320, 420, 520 and may also receive Telemetry and Feedback Data 372, 472, 572 from downstream systems. This subsystem normalizes, timestamps, and harmonizes the incoming metadata and feedback to produce a unified representation for prioritization. No inference, content analysis, or media processing occurs within this subsystem.

The Prioritization Engine (240, 340, 440, 540) evaluates the ingested metadata, optional feedback, and externally supplied operational constraints to compute a priority score or prioritization state for each stream. The Prioritization Engine 240, 340, 440, 540 does not access or analyze raw audio, video, or data content and performs no inference, classification, routing, or media transformation, in embodiments.

The resulting prioritization outputs—such as priority scores 241, 341 or rank-ordered information—are delivered through a distinct interface or API to external Stream-Selection, Grooming & Transcoding subsystems (e.g., 250, 350, 450, 550). These external subsystems, operating outside of the prioritization system 200, 300, 400, 500, 700, determine which streams to select, suppress, groom, adapt, or transmit across constrained network paths (e.g., 260, 360, 460, 560). Any downstream telemetry may be provided back to the ingestion subsystem as Telemetry and Feedback Data but does not alter the internal boundaries or behavior of the prioritization system 200, 300, 400, 500, 700.

Through this workflow, the prioritization system 200, 300, 400, 500, 700 computes prioritization outputs based solely on externally generated metadata, feedback, and operational constraints, while all stream handling, grooming, adaptation, and transmission remain external.

Example Workflows. The following example workflows illustrate representative operating scenarios of the inventive metadata-driven prioritization system. In each case, stream capture, External Analytical Agents, grooming/transcoding subsystems, transport networks, and downstream systems are external to the prioritization system 200, 300, 400, 500, 700. The prioritization system 200, 300, 400, 500, 700 performs metadata and feedback ingestion, priority-score computation, and generation of prioritization outputs.

Example 1—High-Density Surveillance Deployment. A large surveillance environment may include hundreds of external cameras generating continuous video streams. The cameras, encoders, and any preprocessing units are external components. External Analytical Agents—such as AI detectors, scene classifiers, or rule-based analytics engines—produce metadata describing detected objects, motion levels, anomaly indicators, or relevance scores.

An illustrative workflow appears in FIG. 7, where camera streams 711a-711nand metadata generated by External Analytical Agents 720 are ingested by the inventive Metadata & Feedback Ingestion subsystem and evaluated by the Stream Prioritization Engine 740. The resulting prioritization outputs are provided to an External Stream-Selection, Grooming & Transmission subsystem 750 prior to transmission over a Constrained Network 760.

The ingestion subsystem normalizes and harmonizes metadata received from multiple agents. The Prioritization Engine computes priority scores reflecting the relative importance of each surveillance stream, based solely on externally generated metadata and any available Feedback Data such as congestion or bandwidth indicators.

External grooming or selection subsystems interpret these prioritization outputs to determine which feeds are transmitted at full resolution, which are downscaled or sampled, and which may be temporarily suppressed. These selection and transport operations are outside the scope of the prioritization system 200, 300, 400, 500, 700, in embodiments.

Example 2—Multi-Camera Live Broadcast over 5G. In a live production environment, multiple mobile cameras transmit over variable wireless networks such as 5G. The cameras, encoders, and wireless transports are external. External Analytical Agents—such as player-tracking models, ball-tracking engines, or scene-classification tools—produce metadata describing the editorial or contextual relevance of each camera feed.

The Metadata & Feedback Ingestion subsystem receives and normalizes this metadata along with any external operational constraints (e.g., uplink throughput, cell congestion). The internal Prioritization Engine computes priority scores emphasizing action-critical or editorially relevant camera angles.

External Stream-Selection or Grooming subsystems use these prioritization outputs to allocate limited bandwidth, adjust encoding parameters, determine which feeds are transmitted in real-time, or reduce the quality of lower-priority feeds. These decisions and actions are fully external and not performed by the inventive system.

Example 3—Tactical Edge/Defense Operations. A tactical operations center may receive streams from diverse external sources, including body-worn sensors, vehicle-mounted cameras, drones, perimeter detection systems, or fixed surveillance units. External mission-analytics engines generate metadata such as threat indicators, anomaly scores, object or activity classifications, geospatial cues, or sensor-fusion metrics.

The inventive Metadata & Feedback Ingestion subsystem normalizes and harmonizes this metadata before forwarding it to the internal Prioritization Engine. The Prioritization Engine computes dynamic priority scores for each stream based solely on externally generated metadata, optional Feedback Data, and externally supplied operational constraints (e.g., bandwidth budgets, link stability, latency requirements).

External routing or grooming subsystems use these prioritization outputs to determine which streams are forwarded to command personnel over constrained tactical or ad-hoc networks. These routing, grooming, and transmission decisions are performed exclusively by external systems and do not form part of the inventive prioritization system.

Example 4—Smart City/Intelligent Infrastructure. In a smart-city deployment, external sensors and analytics platforms generate metadata describing traffic density, incident detection, pedestrian flows, or environmental conditions. The Metadata & Feedback Ingestion subsystem receives this metadata, and the internal Prioritization Engine computes priority scores based on policy rules, time-of-day considerations, or detected events.

External traffic-management or video-distribution systems act on the resulting prioritization outputs to allocate bandwidth, prioritize particular infrastructure cameras, or route selected streams into archival, monitoring, or analytic systems. Execution of such routing or bandwidth allocation is external to the prioritization system 200, 300, 400, 500, 700, in embodiments.

Algorithms and Pseudocode. The inventive Prioritization Engine may apply a variety of algorithms to compute priority scores, stabilize prioritization behavior, combine metadata originating from multiple External Analytical Agents, and adapt to Feedback Data supplied by downstream systems. The examples below illustrate representative techniques; equivalent variations may be implemented without departing from the scope of the present disclosure. All metadata inputs originate externally; the prioritization system 200, 300, 400, 500, 700 does not perform native media analysis or inference, in embodiments.

Priority Scoring Algorithm. In one embodiment, each stream receives a dynamic numerical score computed strictly from externally generated metadata:

priority_score=(w1*anomaly_score)+(w2*object_detection_confidence)+(w3*motion_intensity)+(w4*scene_importance)+(w5*business_rule_weight)

Each metadata term is produced by External Analytical Agents.

The Prioritization Engine performs no content analysis of its own.

Weights (w1. . . w5) may be fixed, adaptive, or externally defined.

Metadata Fusion Algorithm. Metadata for a single stream may originate from multiple External Analytical Agents. The Metadata & Feedback Ingestion subsystem may normalize and harmonize these inputs:

normalized=normalize([agent1, agent2, agent3])

fusion_score=average(normalized)

Alternative embodiments may use weighted averaging, rule-based selection, max/min strategies, or ensemble methods.

Hysteresis and Stability Mechanisms. To avoid rapid oscillation of selected streams, the Prioritization Engine may apply hysteresis or smoothing techniques:

### Score Thresholding

if abs(current_score-prior_score)<threshold:

current_score=prior_score

### Temporal Smoothing

score=alpha*current+(1−alpha)*prior

Minimum Selection Duration

A stream may remain selected for a minimum period before re-evaluation.

### Hysteresis-management Module

In some embodiments, hysteresis functionality may be implemented within a Hysteresis-Management Module forming part of, or coupled to, the Prioritization Engine or an optional Decision Module.

Such logic applies temporal averaging, score-change thresholds, or damping filters to priority scores or prioritization states, but does not perform stream selection or grooming.

Constraint-Based Selection Logic. The Prioritization Engine evaluates externally supplied operational constraints—such as bandwidth, latency, storage limits, or compute budgets—when producing prioritization outputs.

A simplified example decision-support routine is:

available_bw=constraint_input[“bandwidth_budget”]

sorted_streams=sort_by(priority_score)

prioritization_output=[]

for stream in sorted_streams:

if stream.bitrate<=available_bw:

prioritization_output.append(stream)

available_bw−=stream.bitrate

In certain embodiments, this logic computes prioritized lists or prioritization states for use by external grooming or routing subsystems, but does not itself select, transmit, groom, transcode, or route streams.

Feedback-Based Score Adjustment. Feedback Data from downstream systems may affect future prioritization behavior:
if feedback.indicates_high_usage(stream_id):

priority_score+=feedback_weight

Optional reinforcement learning may also be applied.

Feedback is external and does not enable the prioritization system 200, 300, 400, 500, 700 to control downstream systems.

Hardware and Deployment Environments. The prioritization system 200, 300, 400, 500, 700 may operate within diverse deployment contexts. In any such context, metadata and feedback ingestion, prioritization, and generation of prioritization outputs may be performed by the prioritization system 200, 300, 400, 500, 700, whereas stream capture, analytics, grooming, routing, storage, and transmission may be performed externally to the prioritization system 200, 300, 400, 500, 700. Hardware details described are illustrative and not limiting.

Example Environment—Edge Node Embodiments (External+Internal Hybrid). Edge devices may host both external components (capture devices, encoders, External Analytical Agents) and internal components (Metadata & Feedback Ingestion subsystem and Prioritization Engine).

Example Environment—Cloud or Data Center Embodiments. Cloud environments may host centralized prioritization nodes ingesting metadata produced by distributed External Analytical Agents.

Example Environment—Private 5G/MEC Embodiments. The prioritization system may operate at MEC layers where low-latency access to metadata is available. External 5G devices and analytics engines supply streams and metadata.

Example Environment—Hybrid Edge-Cloud Deployment. Metadata may be partially processed at the edge and fully prioritized in cloud nodes, or vice versa.

Example Environment Aspect—Network Interfaces and Transport Hardware (External). Transport interfaces—Ethernet, bonded cellular, private 5G radios, satellite modems—are external and not controlled by the prioritization system 200, 300, 400, 500, 700.

Example Environment Aspect—Storage and Buffering Systems (External). Temporary buffering, archival storage, or content repositories are external to the prioritization system 200, 300, 400, 500, 700.

Integration Touchpoints. Integration between external components and the prioritization system 200, 300, 400, 500, 700 may occur via REST APIs, gRPC interfaces, KLV metadata streams, message buses, or similar mechanisms.

Example payload:
{“stream_id”:“cam_42”,“metadata”: {. . . }}

The prioritization system 200, 300, 400, 500, 700 may accept any data format and any structure for external metadata or feedback payloads. Any data formats described herein are illustrative rather than limiting.

Federated and Distributed Deployments. FIG. 6 illustrates a federated deployment in which multiple prioritization nodes exchange metadata, priority scores, Feedback Data, and constraint information. Each node may contain internal inventive components—the Metadata & Feedback Ingestion subsystem, Prioritization Engine, and optional Decision Module—while interacting with external capture devices, External Analytical Agents, grooming subsystems, and transport links at that workflow stage.

Nodes may operate autonomously, hierarchically (edge→aggregation→core), or cooperatively. The prioritization system 200, 300, 400, 500, 700 may perform ingestion and prioritization, while capture, analytics, grooming, selection, transcoding, routing, and transmission may be performed externally to the prioritization system 200, 300, 400, 500, 700.

Each federated prioritization node may be or may include a prioritization component operating at an edge, aggregation, or central workflow stage that exchanges metadata, priority scores, or operational constraints with other nodes to support coordinated multi-stage prioritization.

Feedback and Telemetry Embodiments. Downstream systems may supply telemetry such as operator directives, congestion conditions, bandwidth budgets, or policy overrides. The prioritization system 200, 300, 400, 500, 700 may incorporate this information as Feedback Data into the prioritization process but does not control any downstream operations, in embodiments.

In some embodiments, Feedback Data is treated as a specialized class of metadata and may be validated or filtered by a metadata-integrity module before being used by the Prioritization Engine. Validation may include verifying signatures or checksums, ensuring schema conformity, or rejecting metadata values outside predetermined ranges.

Alternative Embodiments. Alternative embodiments may include: rule-only prioritization (no AI metadata), prioritization driven solely by business-rule metadata, single-agent or multi-agent metadata sources, prioritization without stream suppression (e.g., bitrate adaptation only), fully centralized or fully edge-based deployments, asynchronous metadata timing, heterogeneous network or transport environments.

None of these variations alter the inventive core: Metadata & Feedback Ingestion→Prioritization Engine→prioritization outputs based solely on externally generated metadata and external constraints.

In a first aspect of the present disclosure, a computer-implemented method for real-time prioritization of audio, video, and/or data streams available for transmission over a constrained network is provided. The method includes receiving, from one or more logically-independent external sources, externally-generated metadata corresponding to a plurality of streams, each of the plurality of streams comprising one or more of audio, video, or data, wherein an aggregate bitrate of the plurality of streams exceeds an available capacity of the constrained network, normalizing, aggregating, or harmonizing the externally-generated metadata, assigning, based on the normalized, aggregated, or harmonized externally generated metadata, a respective dynamic priority score to each stream without accessing, decoding, analyzing, or processing the audio, video, or data of the stream, evaluating operational constraints of external downstream systems, generating prioritization output data identifying, for each stream, a prioritization output determined according to the assigned priority scores and the operational constraints, and outputting the prioritization output data to the external downstream systems to cause the external downstream systems to selectively transmit at least a subset of the streams over the constrained network based on the prioritization outputs.

In an embodiment of the first aspect, the externally generated metadata includes at least one of: object detection outputs, activity classifications, motion vectors, anomaly indicators, scene descriptors, or geospatial context.

In an embodiment of the first aspect, the method further includes continuously updating the priority scores and the prioritization output data responsive to changes in the received metadata.

In an embodiment of the first aspect, the operational constraints include one or more of: available network bandwidth, compute availability, storage capacity, latency thresholds, link reliability, or cost limitations.

In a second aspect of the present disclosure, a system for real-time prioritization of audio, video, or data streams is provided. The system includes a metadata and feedback ingestion module configured to receive externally generated metadata associated with a plurality of audio, video, or data streams captured by respective external sources, an aggregate bitrate of the plurality of streams being greater than an available capacity of a constrained network, and receive, normalize, and harmonize externally generated metadata produced by one or more logically distinct external analytical agents. The system further includes an inference-agnostic prioritization engine configured to assign, to each stream, a priority score based on the externally-generated metadata without accessing, decoding, or analyzing raw audio, video, or data content of the stream, and a decision module configured to evaluate the priority scores together with externally supplied operational constraints and to generate prioritization output data identifying a prioritization output for each stream, wherein the prioritization output data is configured to be provided to one or more external downstream systems that, responsive to the prioritization outputs, selectively transmit, store, suppress, or route at least a subset of the streams over the constrained network.

In an embodiment of the second aspect, the prioritization engine does not perform native image, audio, or data analysis and operates exclusively on externally generated metadata.

In an embodiment of the second aspect, the system further includes an output interface configured to deliver the prioritization output data to one or more external downstream systems for informing transmission, storage, display, analytics, or stream-conditioning operations.

In an embodiment of the second aspect, the metadata and feedback ingestion module is configured to receive metadata via embedded payload fields, key length value metadata, a representational state transfer application programming interface (API), a remote procedure call API, or a dedicated side-channel interface.

In an embodiment of the second aspect, the prioritization engine is deployable in a centralized, edge-based, or hybrid architecture, and wherein edge components perform local metadata ingestion and scoring while centralized components coordinate prioritization across multiple sites.

In an embodiment of the second aspect, the operational constraints are continuously updated based on real-time assessments of bandwidth availability, storage capacity, processing load, and/or latency requirements.

In an embodiment of the second aspect, the priority scores are computed using a fusion of multiple types of externally generated metadata including at least two of: object detection outputs, activity classifications, motion vectors, anomaly indicators, scene descriptors, or geospatial indicators.

In an embodiment of the second aspect, the system further includes a feedback-ingestion module configured to receive feedback information about the streams from one or more of the downstream systems, telemetry sources, or user interactions, and to dynamically adjust at least one priority score responsive to the feedback information. In a further embodiment of the second aspect, the feedback-ingestion module is distributed across a federated network of prioritization nodes, wherein the federated network of prioritization nodes comprises the prioritization engine.

In an embodiment of the second aspect, the prioritization engine or the decision module incorporates hysteresis logic configured to reduce prioritization instability using one or more of temporal smoothing, score-change thresholds, or damping filters.

In an embodiment of the second aspect, a plurality of instances of the metadata and feedback ingestion module and the prioritization engine are deployed at a plurality of workflow stages, each workflow stage being configured to perform local prioritization of streams based on externally generated metadata received at that workflow stage, and wherein metadata, prioritization output data, or operational constraints produced at one workflow stage is provided to at least one other workflow stage.

In an embodiment of the second aspect, each workflow stage operates autonomously using local metadata and metadata received from at least one additional stage.

In an embodiment of the second aspect, metadata is exchanged between workflow stages in an upstream or downstream direction to support coordinated prioritization.

In an embodiment of the second aspect, priority scores at a given stage are computed using a weighted combination of local metadata and metadata received from other stages.

In an embodiment of the second aspect, external analytical agents further produce business-rule metadata derived from enterprise platforms including customer-relationship-management systems, billing systems, service-orchestration platforms, or network-policy engine

In an embodiment of the second aspect, prioritization outputs are influenced by business-rule factors including service-level-agreement tier, cost of transmission, historical link reliability, or customer entitlement level.

In an embodiment of the second aspect, the feedback-ingestion module ingests one or more of telemetry or user interactions from downstream systems and adjusts priority scores in real time.

In an embodiment of the second aspect, the feedback includes one or more of quality-of-service metrics, operator-selection data, network performance indicators, or content-usage histories.

In an embodiment of the second aspect, the feedback-ingestion module applies adaptive scoring logic including learning-based or rule-based models to refine prioritization behavior over time.

In an embodiment of the second aspect, the system further includes a hysteresis-management module configured to implement stability mechanisms that mitigate prioritization instability, including excessive toggling, in prioritization outputs.

In an embodiment of the second aspect, the hysteresis-management module applies temporal averaging, score-change thresholds, or damping filters.

In an embodiment of the second aspect, the metadata and feedback ingestion module supports communication via one or more of a representational state transfer application programming interface (API), a key length value channel, a message-queue system, or a dedicated side-channel link.

In an embodiment of the second aspect, prioritized streams are transmitted by one or more external downstream systems using adaptive or selective network-transport mechanisms under constrained conditions.

In an embodiment of the second aspect, the system further includes a metadata-integrity module configured to validate metadata received from external agents by verifying signatures, enforcing schema conformity, or rejecting out-of-range values.

In a third aspect of the present disclosure, a non-transitory computer-readable medium is provided storing instructions that, when executed by one or more processors, cause a system comprising the one or more processors to perform a method including receiving, from one or more logically-independent external sources, externally-generated metadata corresponding to a plurality of streams, each of the plurality of streams comprising one or more of audio, video, or data, wherein an aggregate bitrate of the plurality of streams exceeds an available capacity of the constrained network, normalizing, aggregating, or harmonizing the externally-generated metadata, assigning, based on the normalized, aggregated, or harmonized externally generated metadata, a respective dynamic priority score to each stream without accessing, decoding, analyzing, or processing the audio, video, or data of the stream, evaluating operational constraints of external downstream systems, generating prioritization output data identifying, for each stream, a prioritization output determined according to the assigned priority scores and the operational constraints, and outputting the prioritization output data to the external downstream systems to cause the external downstream systems to selectively transmit at least a subset of the streams over the constrained network based on the prioritization outputs.

In an embodiment of the third aspect, the externally generated metadata includes at least one of: object detection outputs, activity classifications, motion vectors, anomaly indicators, scene descriptors, or geospatial context.

In an embodiment of the third aspect, the method further comprises continuously updating the priority scores and the prioritization output data responsive to changes in the received metadata.

In an embodiment of the third aspect, the operational constraints include one or more of: available network bandwidth, compute availability, storage capacity, latency thresholds, link reliability, or cost limitations.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various embodiments of the present invention.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

1. A computer-implemented method for real-time prioritization of audio, video, and/or data streams available for transmission over a constrained network, the method comprising:
receiving, from one or more logically-independent external sources, externally-generated metadata corresponding to a plurality of streams, each of the plurality of streams comprising one or more of audio, video, or data, wherein an aggregate bitrate of the plurality of streams exceeds an available capacity of the constrained network;
normalizing, aggregating, or harmonizing the externally-generated metadata;
assigning, based on the normalized, aggregated, or harmonized externally generated metadata, a respective dynamic priority score to each stream without accessing, decoding, analyzing, or processing the audio, video, or data of the stream;
evaluating operational constraints of external downstream systems;
generating prioritization output data identifying, for each stream, a prioritization output determined according to the assigned priority scores and the operational constraints; and
outputting the prioritization output data to the external downstream systems to cause the external downstream systems to selectively transmit at least a subset of the streams over the constrained network based on the prioritization outputs.

2. The method of claim 1, wherein the externally generated metadata includes at least one of: object detection outputs, activity classifications, motion vectors, anomaly indicators, scene descriptors, or geospatial context.

3. The method of claim 1, further comprising continuously updating the priority scores and the prioritization output data responsive to changes in the received metadata.

4. The method of claim 1, wherein the operational constraints include one or more of:
available network bandwidth, compute availability, storage capacity, latency thresholds, link reliability, or cost limitations.

5. A system for real-time prioritization of audio, video, or data streams, the system comprising:
a metadata and feedback ingestion module configured to:
receive externally generated metadata associated with a plurality of audio, video, or data streams captured by respective external sources, an aggregate bitrate of the plurality of streams being greater than an available capacity of a constrained network; and
receive, normalize, and harmonize externally generated metadata produced by one or more logically distinct external analytical agents;
an inference-agnostic prioritization engine configured to assign, to each stream, a priority score based on the externally-generated metadata without accessing, decoding, or analyzing raw audio, video, or data content of the stream; and
a decision module configured to evaluate the priority scores together with externally supplied operational constraints and to generate prioritization output data identifying a prioritization output for each stream,
wherein the prioritization output data is configured to be provided to one or more external downstream systems that, responsive to the prioritization outputs, selectively transmit, store, suppress, or route at least a subset of the streams over the constrained network.

6. The system of claim 5, wherein the prioritization engine does not perform native image, audio, or data analysis and operates exclusively on externally generated metadata.

7. The system of claim 5, further comprising an output interface configured to deliver the prioritization output data to one or more external downstream systems for informing transmission, storage, display, analytics, or stream-conditioning operations.

8. The system of claim 5, wherein the metadata and feedback ingestion module is configured to receive metadata via embedded payload fields, key length value metadata, a representational state transfer application programming interface (API), a remote procedure call API, or a dedicated side-channel interface.

9. The system of claim 5, wherein the prioritization engine is deployable in a centralized, edge-based, or hybrid architecture, and wherein edge components perform local metadata ingestion and scoring while centralized components coordinate prioritization across multiple sites.

10. The system of claim 5, wherein the operational constraints are continuously updated based on real-time assessments of bandwidth availability, storage capacity, processing load, and/or latency requirements.

11. The system of claim 5, wherein the priority scores are computed using a fusion of multiple types of externally generated metadata including at least two of: object detection outputs, activity classifications, motion vectors, anomaly indicators, scene descriptors, or geospatial indicators.

12. The system of claim 5, further comprising a feedback-ingestion module configured to receive feedback information about the streams from one or more of the downstream systems, telemetry sources, or user interactions, and to dynamically adjust at least one priority score responsive to the feedback information.

13. The system of claim 12, wherein the feedback-ingestion module is distributed across a federated network of prioritization nodes, wherein the federated network of prioritization nodes comprises the prioritization engine.

14. The system of claim 5, wherein the prioritization engine or the decision module incorporates hysteresis logic configured to reduce prioritization instability using one or more of temporal smoothing, score-change thresholds, or damping filters.

15. The system of claim 5, wherein a plurality of instances of the metadata and feedback ingestion module and the prioritization engine are deployed at a plurality of workflow stages, each workflow stage being configured to perform local prioritization of streams based on externally generated metadata received at that workflow stage, and wherein metadata, prioritization output data, or operational constraints produced at one workflow stage is provided to at least one other workflow stage.

16. The system of claim 15, wherein each workflow stage operates autonomously using local metadata and metadata received from at least one additional stage.

17. The system of claim 15, wherein metadata is exchanged between workflow stages in an upstream or downstream direction to support coordinated prioritization.

18. The system of claim 15, wherein priority scores at a given stage are computed using a weighted combination of local metadata and metadata received from other stages.

19. The system of claim 15, wherein external analytical agents further produce business-rule metadata derived from enterprise platforms including customer-relationship-management systems, billing systems, service-orchestration platforms, or network-policy engine

20. The system of claim 12, wherein prioritization outputs are influenced by business-rule factors including service-level-agreement tier, cost of transmission, historical link reliability, or customer entitlement level.

21. The system of claim 12, wherein the feedback-ingestion module ingests one or more of telemetry or user interactions from downstream systems and adjusts priority scores in real time.

22. The system of claim 21, wherein the feedback includes one or more of quality-of-service metrics, operator-selection data, network performance indicators, or content-usage histories.

23. The system of claim 12, wherein the feedback-ingestion module applies adaptive scoring logic including learning-based or rule-based models to refine prioritization behavior over time.

24. The system of claim 5, further comprising a hysteresis-management module configured to implement stability mechanisms that mitigate prioritization instability, including excessive toggling, in prioritization outputs.

25. The system of claim 24, wherein the hysteresis-management module applies temporal averaging, score-change thresholds, or damping filters.

26. The system of claim 5, wherein the metadata and feedback ingestion module supports communication via one or more of a representational state transfer application programming interface (API), a key length value channel, a message-queue system, or a dedicated side-channel link.

27. The system of claim 5, wherein prioritized streams are transmitted by one or more external downstream systems using adaptive or selective network-transport mechanisms under constrained conditions.

28. The system of claim 5, further comprising a metadata-integrity module configured to validate metadata received from external agents by verifying signatures, enforcing schema conformity, or rejecting out-of-range values.

29. A non-transitory computer-readable medium storing instructions that, when executed by one or more processors, cause a system comprising the one or more processors to perform a method comprising:
receiving, from one or more logically-independent external sources, externally-generated metadata corresponding to a plurality of streams, each of the plurality of streams comprising one or more of audio, video, or data, wherein an aggregate bitrate of the plurality of streams exceeds an available capacity of the constrained network;
normalizing, aggregating, or harmonizing the externally-generated metadata;
assigning, based on the normalized, aggregated, or harmonized externally generated metadata, a respective dynamic priority score to each stream without accessing, decoding, analyzing, or processing the audio, video, or data of the stream;
evaluating operational constraints of external downstream systems;
generating prioritization output data identifying, for each stream, a prioritization output determined according to the assigned priority scores and the operational constraints; and
outputting the prioritization output data to the external downstream systems to cause the external downstream systems to selectively transmit at least a subset of the streams over the constrained network based on the prioritization outputs.

30. The non-transitory, computer-readable medium of claim 29, wherein the externally generated metadata includes at least one of: object detection outputs, activity classifications, motion vectors, anomaly indicators, scene descriptors, or geospatial context.

31. The non-transitory, computer-readable medium of claim 29, wherein the method further comprises continuously updating the priority scores and the prioritization output data responsive to changes in the received metadata.

32. The non-transitory, computer-readable medium of claim 29, wherein the operational constraints include one or more of: available network bandwidth, compute availability, storage capacity, latency thresholds, link reliability, or cost limitations.
